(19) United States
(12) Patent Application Publication
(10) Pub. No.: US 2017/0165030 A1
(43) Pub. Date: Jun. 15, 2017

(54) PLANNING AND GUIDING METHOD AND EXCAVATION GUIDING DEVICE FOR CORRECTLY IMPLANTING ARTIFICIAL TOOTH ROOT AT PREDETERMINED SITE

(71) Applicant: EN-HENG LIU, New Taipei City (TW)

(72) Inventor: EN-HENG LIU, New Taipei City (TW)

(21) Appl. No.: 14/968,744

(22) Filed: Dec. 14, 2015

(51) Int. Cl. A61C 1/08; A61C 8/00

(52) U.S. Cl. CPC A61C 1/084; A61C 8/0089

(57) ABSTRACT

A planning and guiding method and excavation guiding device correctly implant an artificial tooth root at a predetermined site, perform various excavation processes on a cortical bone section and a spongy bone section by stage-based guidance, and guide eccentric excavation of the cortical bone section and concentric excavation of the spongy bone section according to a bone pattern, such that the artificial tooth root thus implanted is not only positioned at a planned ideal site but also manifests appropriate initial stability.

### FIELD OF THE INVENTION

The present invention relates to planning and guiding methods and excavation guiding devices for use with an artificial tooth root and more particularly to a planning and guiding method and excavation guiding device for correctly implanting an artificial tooth root at a predetermined site.

### BACKGROUND OF THE INVENTION

Dental implant surgery is a procedure that implants an artificial tooth root in the jawbone and then mounts an artificial crown on the artificial tooth root so that the prosthetic tooth not only looks attractive but is also effective in chewing. Although conventional implantation techniques are advantageously stable, safe, and conducive to long-term efficacy as well as esthetic enhancement, incorrect sites of implantation render dental implants ineffective.

A conventional implantation guiding device performs a tomography scan on the jawbone, creates a virtual implantation site in a 3D image with computer software, plans a drill guiding bushing site, and eventually produces a physical guiding positioning template by computer-aided manufacturing techniques or 3D printing. Referring to FIG. 1, there is shown a schematic view of the use of a conventional guiding positioning template. As shown in the diagram, a guiding positioning template 1 is mounted at a patient's implantation site, and then the orientation of excavation carried out with a drill 11 is guided by a drill guiding ring 10 of the guiding positioning template 1, such that the excavation is carried out at a predetermined site of an implant platform in the implant axial direction. Upon completion of the excavation, an implant is placed in the excavated hole and therefore fixed to the alveolar bone.

The axial direction of the drill guiding ring 10 of the conventional guiding positioning template 1 is the same as the axial direction of a planned artificial implant, and a concentric reaming process is carried out with a small-diameter drill successively replaced by drills of increasingly large diameters. The aforesaid guidance is reliable when performed on a flat homogeneous alveolar bone; however, After tooth extraction, the thin buccal portion of the alveolar ridge is absorbed and therefore disappears in several months; as a result, dental implant surgery is often confronted with an alveolar ridge with a low buccal side and a high lingual side, and therefore the drill or implant used in the course of excavation and in the course of implantation is likely to tilt and shift toward the low-resistance buccal side, and in consequence the implant is seldom placed at a planned ideal site.

Furthermore, to achieve perfect implantation, not only must the implant be positioned at an ideal site, but the implant also has to manifest appropriate initial stability. Depending on the bone pattern of the alveolar bone, the site of excavation of a cortical bone section determines the site of the implant platform after implantation, and a small-diameter reaming process performed at a spongy bone section enhances the initial stability of the implant thus positioned.

FIG. 2a is a schematic view of performing excavation with a small-diameter drill before conventional concentric excavation begins. FIG. 2b is a schematic view of a shift which occurs during conventional concentric excavation. Although a small-diameter drill is able to align itself with a predetermined excavation axis during the early phase of reaming, a large-diameter drill introduced into the middle and late phases of reaming is likely to tilt toward the low-resistance side in the course of excavation even when guided by the drill guiding ring, due to the aforesaid problem with an alveolar ridge.

To enhance the initial stability of an implant inserted, the final diameter of the excavated hole is usually 0.5˜0.7 mm less than the diameter of the implant. In response to the low-speed insertion of the implant, the bone cracks and clamps the screw-like artificial tooth root. The bone cracks in the direction of a point of low osseous resistance, and the implant platform shifts in the direction of a point of low resistance.

In view of this, it is important to provide a planning and guiding device for correctly implanting an artificial tooth root at an ideal predetermined site and enabling the implant to manifest appropriate initial stability.

### SUMMARY OF THE INVENTION

It is an objective of the present invention to correctly implant an artificial tooth root at an ideal predetermined site.

It is another objective of the present invention to enable the artificial tooth root thus implanted to manifest appropriate initial stability.

In order to achieve the above and other objectives, the present invention provides a planning and guiding method for correctly implanting an artificial tooth root at a predetermined site, the planning and guiding method comprising: a first stage guiding step of guiding a drill in excavating a cortical bone section in an implant axial direction of an implant platform predetermined site in case of equal osseous resistance to effectuate concentric excavation of the cortical bone section and guiding the drill in shifting horizontally in the implant axial direction of the implant platform predetermined site in case of different osseous resistance to effectuate eccentric excavation of the cortical bone section, according to a bone pattern in vicinity of the implant platform predetermined site; and a second stage guiding step of guiding the drill in effectuating concentric excavation of a spongy bone section in the implant axial direction.

In an embodiment of the present invention the first stage guiding step further comprises guiding the drill in shifting laterally toward a point of high osseous resistance in the implant axial direction in case of different osseous resistance.

In an embodiment of the present invention, the drill for use in the first stage guiding step is a ring saw drill, and the drill for use in the second stage guiding step has a guiding long-neck portion.

In an embodiment of the present invention, in the first stage guiding step, an excavation diameter of the drill for use in eccentric excavation is 1.0 mm˜1.5 mm less than a diameter of the implant.

In an embodiment of the present invention, in the second stage guiding step, the guiding long-neck portion of the drill for use in concentric excavation has a neck diameter of approximately 2 mm˜5 mm.

In an embodiment of the present invention, in the second stage guiding step, the guiding long-neck portion of the drill for use in concentric excavation has a neck diameter of approximately 2.8 mm.

In order to achieve the above and other objectives, the present invention further provides an excavation guiding device for correctly implanting an artificial tooth root at a predetermined site, with the excavation guiding device mounted on an implantation guiding plate to guide a drill in excavating in an implant axial direction of an implant platform predetermined site, the excavation guiding device comprising: a first stage guiding bushing having a first protruding element movably coupled to the implantation guiding plate and a first bushing portion extending from the protruding element, with the first bushing portion adapted to limit a horizontal position of the drill when inserted; and a second stage guiding bushing having a second protruding element movably coupled to the implantation guiding plate and a second bushing portion extending from the protruding element, with the second bushing portion adapted to limit a horizontal position of the drill when inserted, wherein, depending on a bone pattern in vicinity of the implant platform predetermined site, the first stage guiding bushing guides the drill in excavating a cortical bone section in the implant axial direction in case of equal osseous resistance to effectuate concentric excavation of the cortical bone section and guides the drill in shifting laterally in the implant axial direction in case of different osseous resistance to effectuate eccentric excavation of the cortical bone section, wherein the second stage guiding bushing guides the drill in effectuating concentric excavation of a spongy bone section in the implant axial direction.

In an embodiment of the present invention, the inner diameter of the second bushing portion of the second stage guiding bushing is approximately 2 mm˜5 mm.

In an embodiment of the present invention, the inner diameter of the second bushing portion of the second stage guiding bushing is approximately 2.8 mm.

### BRIEF DESCRIPTION OF THE DRAWINGS

Objectives, features, and advantages of the present invention are hereunder illustrated with specific embodiments in conjunction with the accompanying drawings, in which:

FIG. 1 (PRIOR ART) is a schematic view of the use of a conventional guiding positioning template;

FIG. 2a (PRIOR ART) is a schematic view of performing excavation with a small-diameter drill before conventional concentric excavation begins;

FIG. 2 b (PRIOR ART) is a schematic view of a shift which occurs during conventional concentric excavation;

FIG. 3 is a schematic view of the process flow of a planning and guiding method for use in stage-based guidance and eccentric excavation according to an embodiment of the present invention;

FIG. 4a is a schematic view of an implantation guiding plate mounted at an implantation site according to an embodiment of the present invention;

FIG. 4b is a schematic view of a first stage guiding bushing mounted on the implantation guiding plate according to an embodiment of the present invention;

FIG. 4c is a schematic view of a second stage guiding bushing mounted on the implantation guiding plate according to an embodiment of the present invention;

FIG. 5 is a schematic view of orientation of eccentric and concentric excavation;

FIG. 6a is a schematic view of an illustrative aspect of uneven distribution of a bone pattern of alveolar bone; and

FIG. 6b is a schematic view of the implant being subjected to different degrees of osseous resistance during insertion.

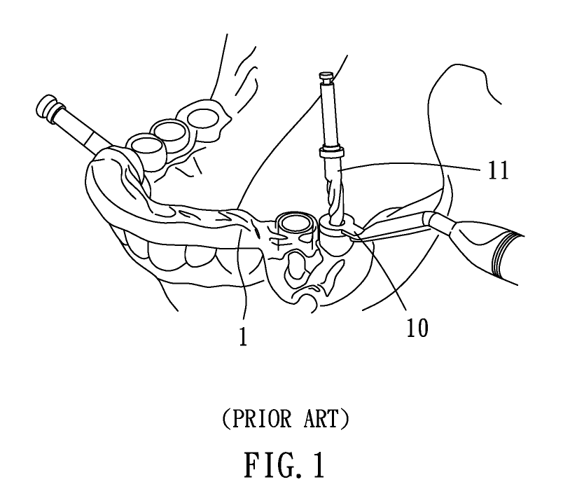

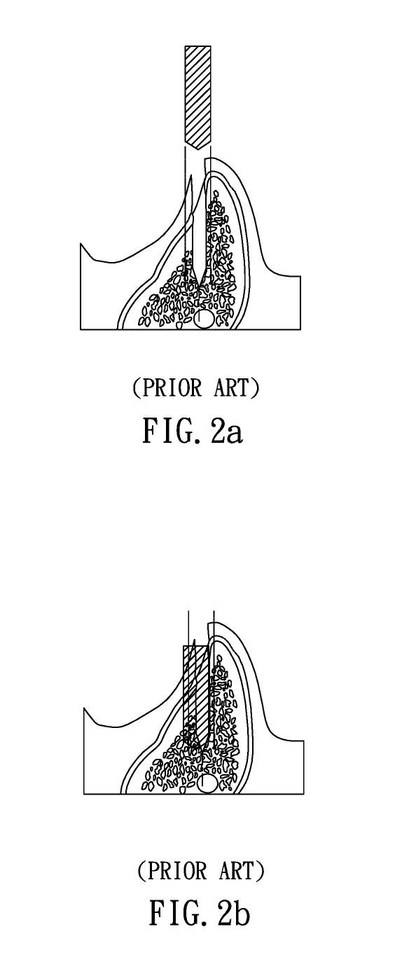

### DETAILED DESCRIPTION OF THE PREFERRED EMBODIMENTS

The initial stability of an implant and whether the implant is actually placed at a planned ideal site correlate significantly with the excavation pattern and the bone pattern of the alveolar bone. In view of this, the present invention discloses a planning and guiding method and excavation guiding device for carrying out excavation at an excavation site subjected to lateral shift and stage-based guidance.

The human jawbone is formed from two types of osseous tissue, namely cortical bone and spongy bone. Cortical bone, which forms the outer shell of the bone, is dense and hard. Spongy bone, which forms the core of the bone, is less dense and softer. A guiding ring site of the present invention is designed according to a planned predetermined site of an implant. The adjective “stage-based” (also known as “two-stage”) is descriptive of the two-stage guidance which takes place at a cortical bone section and a spongy bone section. The eccentric excavation of the cortical bone section is guided in a manner that it shifts within the border of the implant platform site initially planned. The direction and magnitude of the shift is determined by evaluating the height, thickness and density of the bone in the vicinity of the implant platform, using computer tomography images. The eccentric excavation of the cortical bone section is configured to enable the implant to shift, in the course of low-speed insertion, to a planned site automatically and attain appropriate initial stability.

The implantation process, for example, comprises a tooth molding step, an implant platform's ideal site determining step, a step of performing a computer tomography scan to identify an osseous pattern and making an implantation guiding plate and a guiding bushing, a step of mounting the implantation guiding plate on a patient's tooth and mounting the guiding device on the implantation guiding plate, an excavation step, and an implant inserting step. According to the present invention, the guiding bushing is conducive to two-stage excavation.

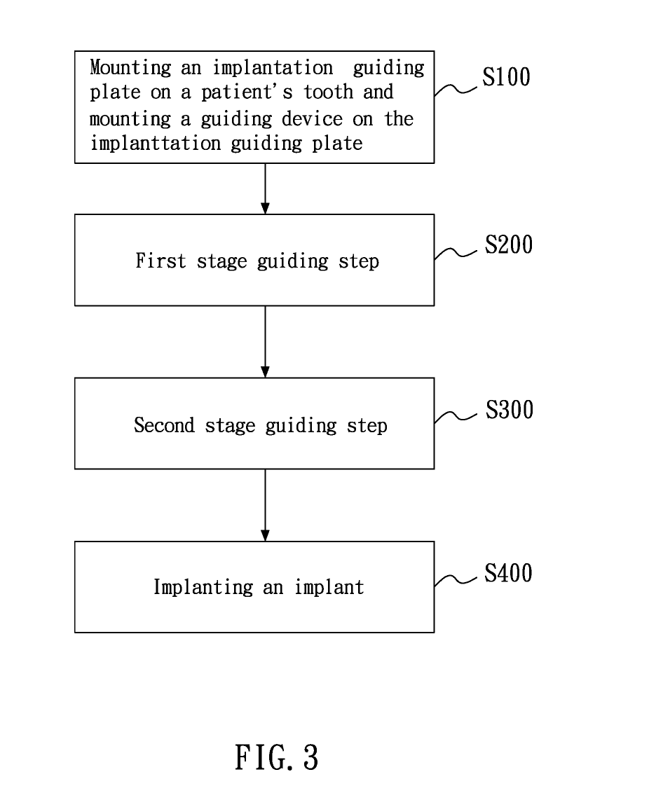

Referring to FIG. 3, there is shown a schematic view of the process flow of a planning and guiding method for use in stage-based guidance and eccentric excavation according to an embodiment of the present invention.

S100: mounting an implantation guiding plate on a patient's tooth and mounting a guiding device on the implantation guiding plate;

S200: first stage guiding step;

S300: second stage guiding step; and

S400: implanting an implant.

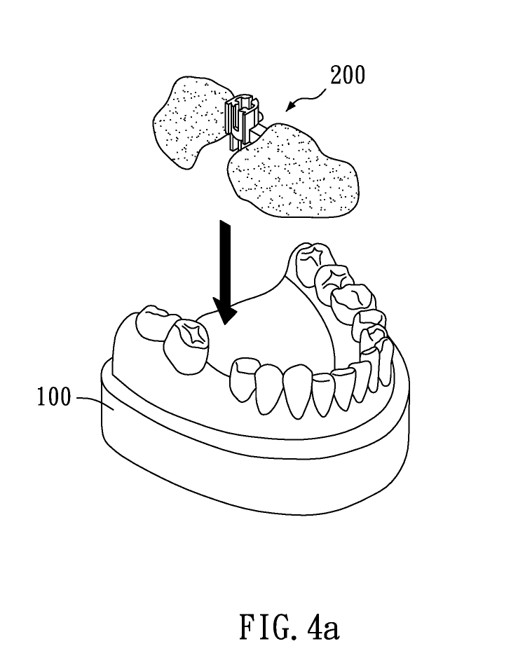

Referring to FIGS. 4a, 4b and 4(c), FIG. 4a is a schematic view of an implantation guiding plate mounted at an implantation site according to an embodiment of the present invention, FIG. 4b is a schematic view of a first stage guiding bushing mounted on the implantation guiding plate according to an embodiment of the present invention, and FIG. 4(c) is a schematic view of a second stage guiding bushing mounted on the implantation guiding plate according to an embodiment of the present invention.

In steps S100, S200, as shown in FIG. 4a and FIG. 4b, an implantation guiding plate 200 is mounted on a patient's tooth 100, and then a first stage guiding bushing 310 is mounted on the implantation guiding plate 200 to perform the first stage guiding step S200. In step S300, as shown in FIG. 4(c), the first stage guiding bushing 310 is replaced with a second stage guiding bushing 320 to perform the second stage guiding step S300. Finally, an implant is implanted at an excavated implantation site (S400).

According to the present invention, the planning and guiding method for correctly implanting an artificial tooth root at a predetermined site comprises the first stage guiding step (S200) and the second stage guiding step (S300). The first stage guiding step (S200) involves guiding the drill in excavating the cortical bone section in an implant axial direction of an implant platform predetermined site in case of equal osseous resistance to effectuate concentric excavation of the cortical bone section and guiding the drill in shifting horizontally in the implant axial direction of the implant platform predetermined site in case of different osseous resistance to effectuate eccentric excavation of the cortical bone section, according to a bone pattern in vicinity of the implant platform predetermined site. Therefore, the first stage guiding step (S200) requires the first stage guiding bushing 310. The first stage guiding bushing 310 has a first protruding element 312 movably coupled to a socket 202 of the implantation guiding plate 200 and a first bushing portion 314 extending from the first protruding element 312. The first bushing portion 314 limits a horizontal position of the drill when inserted. The second stage guiding step (S300) requires the second stage guiding bushing 320. The second stage guiding bushing 320 has a second protruding element 322 movably coupled to the socket 202 of the implantation guiding plate 200 and a second bushing portion 324 extending from the second protruding element 322. The second bushing portion 324 limits a horizontal position of the drill when inserted.

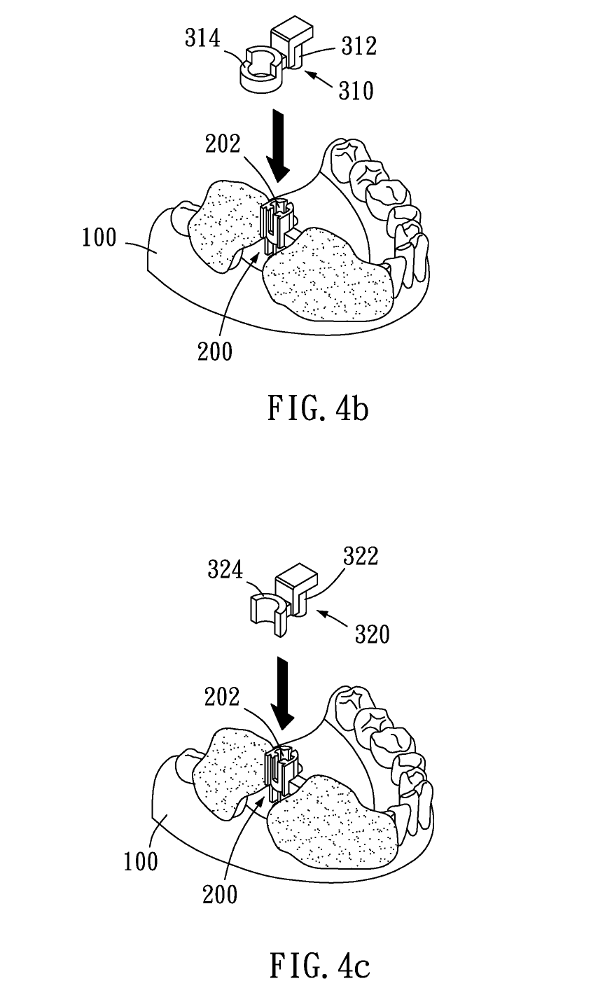

Referring to FIG. 5, there is shown a schematic view of orientation of eccentric and concentric excavation. The orientation of eccentric and concentric excavation is determined in accordance with the axis of the planned implant site. The aspect of eccentric excavation is depicted on the left of FIG. 5, whereas the aspect of concentric excavation is depicted on the right of FIG. 5, such that the direction of the shift (also known as axial shift) is determined according to the bone pattern of the alveolar bone and by a computer tomography scan taken from the top. The eccentric excavation is carried out not only in the bucco-lingual direction but also in the mesiodistal direction, the adjustment of the two directions brings about oblique eccentric excavation (indicative of larger osseous resistance at the upper right) shown on the left of FIG. 5, that is, uneven distribution of osseous resistance is likely to occur in the bucco-lingual direction or/and the mesiodistal direction, which should be considered during the design process of the orientation of eccentric excavation.

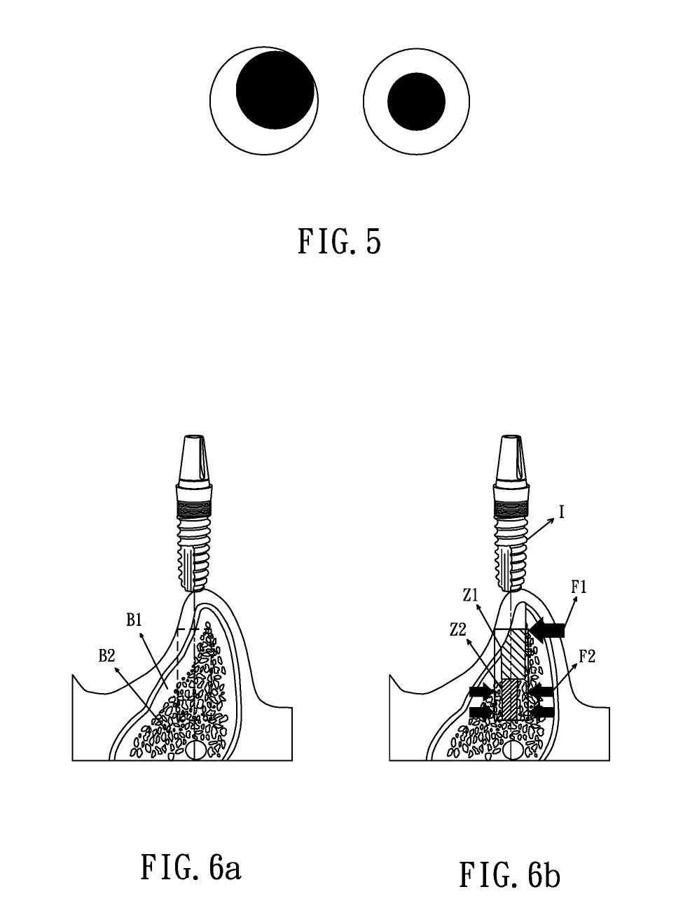

Referring to FIG. 6a, there is shown a schematic view of an illustrative aspect of uneven distribution of a bone pattern of alveolar bone. As shown in FIG. 6a, the distribution of the bone patterns of the cortical bone section layer B1 and the spongy bone section layer B2 in the alveolar bone is evaluated (with computer tomography images), wherein the dashed line box indicates a planned ideal implant site (also known as implant platform predetermined site). As shown in FIG. 6a, a force of uneven resistance is exerted on the axis of the implant site from both the left and right whether during excavation or implantation. Referring to FIG. 6a, the drill or implant comes into contact with the high rightward-located cortical bone section layer B1 first to thereby produce a force under which the drill or implant shifts leftward. According to the prior art, the drill is always guided to the axis of the implant site and then driven downward to begin the excavation process or the implantation process; hence, a shift occurs, thereby preventing the implant from being correctly implanted at the planned site and compromising the stability of the implant.

Referring to FIG. 6b, there is shown a schematic view of the implant being subjected to different degrees of osseous resistance during insertion. To improve the situation arising from the uneven distribution of the bone patterns of the alveolar bone, as shown in FIG. 6a, the first stage guiding step involves shifting the excavation site toward a point of high resistance (i.e., the point at which resistance is generated first) with a first stage guiding bushing to thereby carry out excavation with a horizontal shift and form a first stage guiding zone Z1 (excavation site). Due to the horizontal shift, the implant can be placed at the planned site correctly under a strong lateral acting force F1 at the cortical bone section.

For example, the drill for use in the first stage guiding step is a ring saw drill. Regarding the eccentric excavation carried out in the first stage guiding step, the excavation diameter of the drill is 1.0 mm˜1.5 mm less than the diameter of the implant. The first stage guiding bushing is a closed circumferential bushing (i.e., the first stage guiding bushing 310 shown in FIG. 4b) or a U-shaped open circumferential bushing, which encircles the drill.

Referring to FIG. 6b, upon completion of the excavation of the cortical bone section, with the spongy bone section being soft, the second stage guiding step involves effectuating concentric excavation with the second stage guiding bushing, thereby dispensing with the need for a shift. It is because, in this excavation step, a second stage guiding zone Z2 (excavation site) thus formed is located at the spongy bone section subjected to a weak lateral acting force F2, and in consequence the drill or implant is not subjected to any thrust which may cause a shift. For example, in the second stage guiding step, the drill is a twist drill with a long-handled guiding long-neck portion. Regarding the concentric excavation carried out in the second stage guiding step, the drill head of the guiding long-neck portion of the drill has a diameter of approximately 2 mm˜5 mm. The drill head of the guiding long-neck portion of the drill under a preferred case has a diameter of approximately 2.8 mm. The second stage guiding bushing is a U-shaped open circumferential bushing (i.e., the second bushing portion 324 of the second stage guiding bushing 320 shown in FIG. 4(c)) or a closed circumferential bushing, which encircles the drill. The inner diameter of the second bushing portion of the second stage guiding bushing is approximately 2 mm˜5 mm. In a preferred case, the inner diameter of the second bushing portion of the second stage guiding bushing is approximately 2.8 mm.

FIGS. 6a and 6b show bone patterns taken in a cross-section direction, shift orientation (eccentric orientation shown in FIG. 5) in a top view direction is still determined according to bone distribution pattern of top view angles, when it comes to eccentric excavation.

In conclusion, the description of the present invention allows persons skilled in the art to understand that the prior art is predisposed to implant shift because, in case of different degrees of osseous resistance at the cortical bone section, an implant shifts toward a point of low resistance in the course of low-speed insertion. The present invention provides a planning and guiding method and excavation guiding device for correctly implanting an artificial tooth root at a predetermined site, and in case of uneven osseous resistance of the alveolar bone, effectuating shift excavation of the cortical bone section in the direction of a point of high osseous resistance, and effectuating concentric excavation of the spongy bone section, such that the artificial tooth root thus implanted is not only positioned at a planned predetermined site but also manifests appropriate initial stability.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A planning and guiding method for correctly implanting an artificial tooth root at a predetermined site, the planning and guiding method comprising:
a first stage guiding step of guiding a drill in excavating a cortical bone section in an implant axial direction of an implant platform predetermined site in case of equal osseous resistance to effectuate concentric excavation of the cortical bone section and guiding the drill in shifting horizontally in the implant axial direction of the implant platform predetermined site in case of different osseous resistance to effectuate eccentric excavation of the cortical bone section, according to a bone pattern in vicinity of the implant platform predetermined site; and
a second stage guiding step of guiding the drill in effectuating concentric excavation of a spongy bone section in the implant axial direction.

2. The planning and guiding method of claim 1, wherein the first stage guiding step further comprises guiding the drill in shifting laterally toward a point of high osseous resistance in the implant axial direction in case of different osseous resistance.

3. The planning and guiding method of claim 2, wherein the drill for use in the first stage guiding step is a ring saw drill, and the drill for use in the second stage guiding step has a guiding long-neck portion.

4. The planning and guiding method of claim 3, wherein, in the first stage guiding step, an excavation diameter of the drill for use in eccentric excavation is 1.0 mm˜1.5 mm less than a diameter of the implant.

5. The planning and guiding method of claim 3, wherein, in the second stage guiding step, the guiding long-neck portion of the drill for use in concentric excavation has a neck diameter of approximately 2 mm˜5 mm.

6. The planning and guiding method of claim 3, wherein, in the second stage guiding step, the guiding long-neck portion of the drill for use in concentric excavation has a neck diameter of approximately 2.8 mm.

7. An excavation guiding device for correctly implanting an artificial tooth root at a predetermined site, with the excavation guiding device mounted on an implantation guiding plate to guide a drill in excavating in an implant axial direction of an implant platform predetermined site, the excavation guiding device comprising:
a first stage guiding bushing having a first protruding element movably coupled to the implantation guiding plate and a first bushing portion extending from the protruding element, with the first bushing portion adapted to limit a horizontal position of the drill when inserted; and
a second stage guiding bushing having a second protruding element movably coupled to the implantation guiding plate and a second bushing portion extending from the protruding element, with the second bushing portion adapted to limit a horizontal position of the drill when inserted,
wherein, depending on a bone pattern in vicinity of the implant platform predetermined site, the first stage guiding bushing guides the drill in excavating a cortical bone section in the implant axial direction in case of equal osseous resistance to effectuate concentric excavation of the cortical bone section and guides the drill in shifting laterally in the implant axial direction in case of different osseous resistance to effectuate eccentric excavation of the cortical bone section,
wherein the second stage guiding bushing guides the drill in effectuating concentric excavation of a spongy bone section in the implant axial direction.

8. The excavation guiding device of claim 7, wherein the first stage guiding bushing guides the drill in shifting laterally toward a point of high osseous resistance in the implant axial direction in case of variation in osseous resistance.

9. The excavation guiding device of claim 8, wherein each of the first stage guiding bushing and the second stage guiding bushing is one of a closed circumferential bushing and a U-shaped open circumferential bushing, which encircle the drill.

10. The excavation guiding device of claim 9, wherein the drill for use with the first stage guiding bushing is a ring saw drill, and the drill for use with the second stage guiding bushing has a guiding long-neck portion.

11. The excavation guiding device of claim 10, wherein the first stage guiding bushing and the second stage guiding bushing each have an inner rim with a smooth surface, and the drill has a circumferential surface with a portion thereof being smooth when in contact with a corresponding one of the first and second stage guiding bushing during excavation.

12. The excavation guiding device of claim 11, wherein an excavation diameter of the drill for use with the first stage guiding bushing is 1.0 mm˜1.5 mm less than a diameter of the implant.

13. The excavation guiding device of claim 11, wherein an inner diameter of the second bushing portion of the second stage guiding bushing is approximately 2 mm˜5 mm.

14. The excavation guiding device of claim 11, wherein an inner diameter of the second bushing portion of the second stage guiding bushing is approximately 2.8 mm.
